(19) United States
(12) Patent Application Publication
(10) Pub. No.: US 2019/0236712 A1
(43) Pub. Date: Aug. 1, 2019

(54) SECURE DISPUTE SETTLEMENT SYSTEM

(71) Applicant: Michael Horowitz, McLean, VA (US)

(72) Inventor: Michael Horowitz, McLean, VA (US)

(21) Appl. No.: 16/252,375

(22) Filed: Jan. 18, 2019

Related U.S. Application Data
(60) Provisional application No. 62/622,330, filed on Jan. 26, 2018.

(51) Int. Cl. G06Q 40/08; H04L 9/14

(52) U.S. Cl. CPC G06Q 40/08; G06Q 2220/00; H04L 9/14

(57) ABSTRACT

A secure dispute settlement system is described. The secure dispute settlement system may receive first injury data associated with first injuries of an injured party. The secure dispute settlement system may identify, based on the first injury data, historical settlement data associated with a historical settlement. The historical settlement data may indicate second injury data associated with second injuries that are similar to the first injuries, and a value that the second injuries were settled for. The secure dispute settlement system may generate, based on the historical settlement, a settlement report that indicates an estimated fair value for the first injuries.

### RELATED APPLICATIONS

This application claims the benefit of U.S. Provisional Application No. 62/622,330, filed Jan. 26, 2018, the entire contents of which are incorporated herein by reference.

### BACKGROUND

Currently, persons who are injured and wish to recover for their injuries have few options for recovering the fair value of their claims. This is largely because injured parties do not have any way of estimating the value of the settlement that they are entitled to. Instead, injured parties are largely limited to gaining information from defendant insurers and retaining a tort attorney. Unfortunately, neither of these options are ideal. For example, because it is the defendant insurers who must pay out the claim, defendant insurers are incentivized to offer the lowest evaluation they can, meaning that injured parties cannot rely on the defendant insurers to give a fair appraisal of their damages. Additionally, because tort attorneys are able to charge monopoly pricing, the current injury settlement system imposes very high transactional costs on injured parties to retrieve the money they owed. These high transaction costs also substantially increase the cost of all payments made, which burdens the insurance system with higher costs which are subsequently pushed down to insurance consumers in the form of higher insurance premiums.

### BRIEF DESCRIPTION OF THE DRAWINGS

The detailed description is described with reference to the accompanying figures. In the figures, the left-most digit(s) of a reference number identifies the figure in which the reference number first appears. The same reference numbers in different figures indicate similar or identical items.

FIG. 1A is an illustrative environment for efficiently securing optimal settlements for injured parties.

FIG. 1B is an illustrative environment for efficiently securing optimal settlements for injured parties using a third-party settlement estimation service.

FIG. 2 is an illustrative computing architecture of a computing device configured to efficiently secure optimal settlements for injured parties.

FIG. 3 is a flow diagram of an illustrative process for efficiently securing optimal settlements for injured parties.

FIG. 4 is a flow diagram of an illustrative process for using a third-party estimation service to efficiently secure optimal settlements for injured parties.

FIG. 5 is a flow diagram of an illustrative process for using a third-party estimation service to efficiently secure optimal settlements from a defendant insurer.

FIG. 6 is a flow diagram of an illustrative technical processes for protecting private information during transmissions within a system for securing optimal settlements for injured parties

### DETAILED DESCRIPTION

This disclosure is generally directed to a damages settlement system that allows injured parties to efficiently secure an optimal settlement for their injuries. The damages settlement system may provide injured parties with access to information previously limited to a few insider institutions (e.g., insurance companies, tort attorneys, etc.), thus allowing the injured parties to accurately estimate fair value for their injuries and improve their negotiating position. Additionally, because the transactional costs of using the damages settlement service to obtain injury settlements is so low, the described damages settlement system incentivizes defendant insurance companies to make higher settlement offers to injured parties in order to quickly end cases, prevent the inclusion of an attorney, or otherwise reduce the transactional costs that are incurred by defendant insurance companies during the injury settlement process. This not only results in increased settlements, but it also lowers the operating costs of defendant insurance companies which may result in a reduction of costs for insurance policy holders.

The damages settlement system described herein may also act as a mechanism for separating legal services and information services. That is, by providing injured parties with a reliable way to value their settlement claims, injured parties are freed to obtain legal assistance (and pay any associated contingency fees) in situations where the injured party, the damages settlement system, and/or another party identify an opportunity for legal services provide additional value. For example, in addition to estimating the value of the injured parties' claim, the damages settlement system may also flag situations where legal assistance would be likely to provide a marked improvement in settlement for the injured party. In this way, the damages settlement system promotes the legal system's presently unenforced ethics and fiduciary relationship rules by closing the information gap between attorneys and injured parties about the baseline values of their injury claims, and restricting the ability of attorneys to charge contingency fees where no real contingency of non-payment exists (i.e., when the payment by the insurance company is guaranteed, the damages amount will be a known amount independent of legal services provided, thus there is no contingency of non-payment).

The damages settlement system may also secure data for its estimates and provide settlement estimate packages to defendant insurers using processes for securing the security or injured party data and validity/authenticity of the value estimates. The damages settlement system may utilize secure data verification techniques to assemble accurate and verifiable claim packages, generate settlement estimates of the value of the injured parties' claim based on the claim packages, and provide the settlement estimates to defendant insurers and/or the injured parties. In some embodiments, the settlement estimates may include encrypted elements that allow defendant insurers to quickly verify the validity of the facts of the injured parties. In this way, not only may the system allow injured parties to negotiate potential settlements from an educated position, but it also provides security processes and/or validation services that enable defendant insurers to trust the value estimate and/or independently verify the estimate and the component injury data.

The techniques, apparatuses, and systems described herein may be implemented in a number of ways. Example implementations are provided below with reference to the following figures.

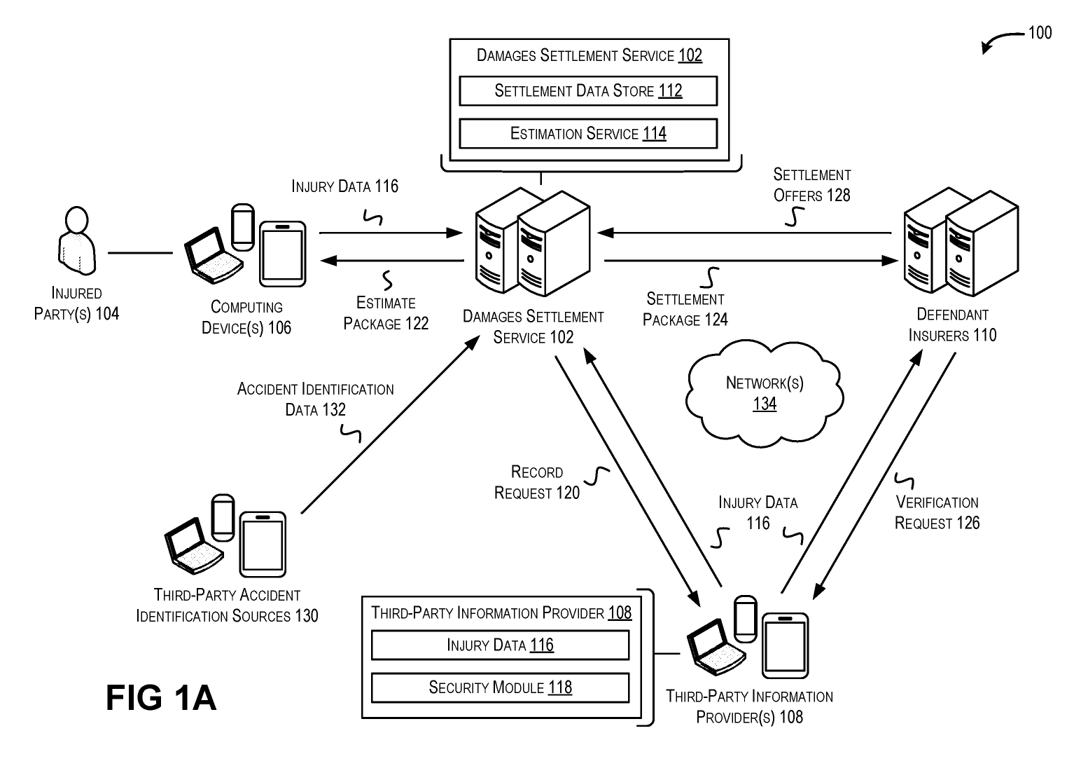

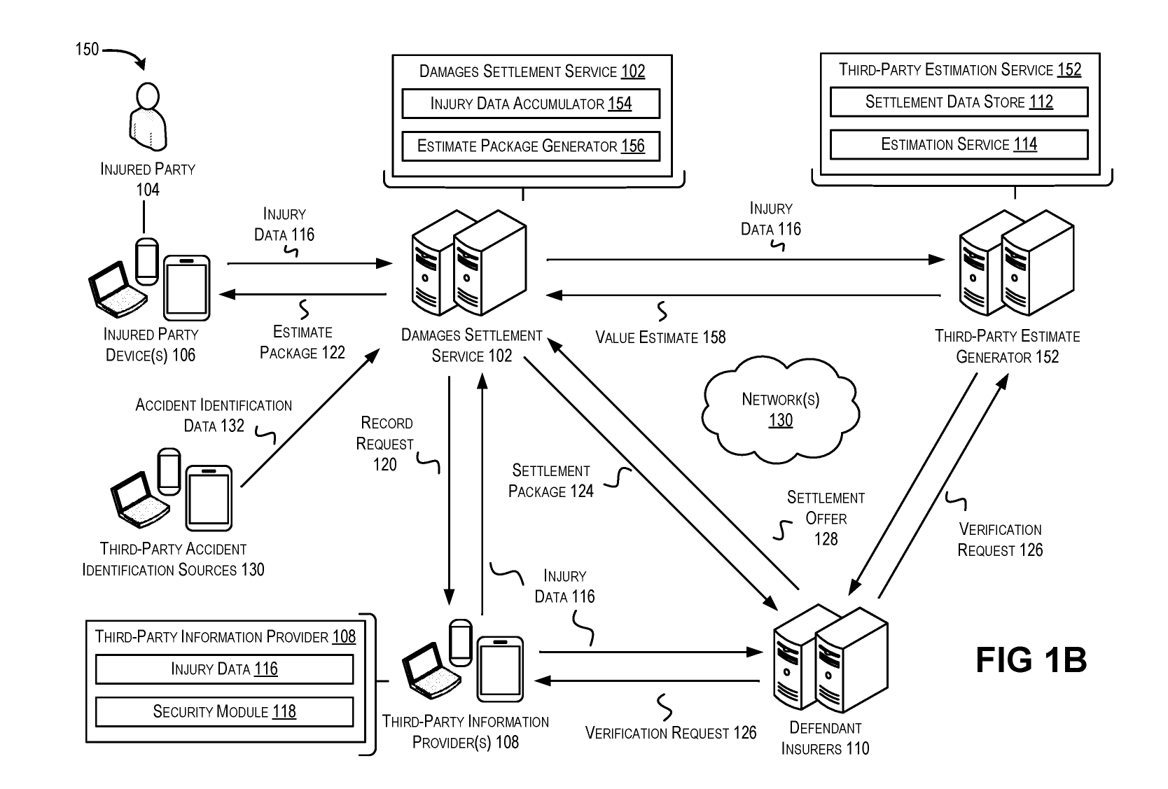

FIG. 1A is a schematic diagram of an illustrative environment 100 for efficiently securing optimal settlements for injured parties. The environment 100 includes a damages settlement service 102, an injured party 104, and one or more computing devices 106 associated with the injured party 104. Environment 100 further includes one or more third-party information providers 108 and defendant insurers 110.

The damages settlement service 102, one or more computing devices 106, third-party information provider 108, and defendant insurers 110 may each include any combination of one or more types of computing devices such as laptop computers, personal computers, voice controlled computing devices, tablet devices, mobile telephones, server(s), platforms, etc. Any such device may include one or more processor(s), computer-readable media, speakers, a display, etc.

FIG. 1A further illustrates damages settlement service 102 as including a settlement data store 112 and an estimation service 114. The settlement data store 112 may be a database that contains historical settlement information associated with the previous injury settlements between injured parties 104 and defendant insurers 110. For example, settlement data store 112 may identify the settlement value of individual settlements (e.g., how much the injured party received as compensation), factual traits of individual settlements (e.g., description of accident, cause of injury, severity of injury, location of accident, type of injury, traits of injured party, parties involved in the accident, fault of injured and/or other party(s), whether an attorney/representative was involved, etc.), timelines of settlements, and/or other information relating to previous settlements between injured parties and insurance companies. The historical settlement information may be acquired from other entities, may be built up over time by the damages settlement service 102, or a combination thereof. For example, the damages settlement service 102 may acquire a first portion of the historical settlement information by acquiring information detailing settlements from insurance companies, and a second portion of the historical settlement information by saving information from injuries where the damages settlement service 102 assisted in reaching a settlement.

The estimation service 114 may enable the damages settlement service 102 to utilize the historical settlement information stored in the settlement data store 112 to determine an estimated value of an injury settlement for an injured party 104. For example, the estimation service 114 may compare accident information associated with an injured party 104 to historical settlement information stored in the settlement data store 112 to identify one or more settlement amounts that injuries with similar accident information settled for, and then estimate a settlement range that would likely represent fair compensation for the injured party's 104 damages.

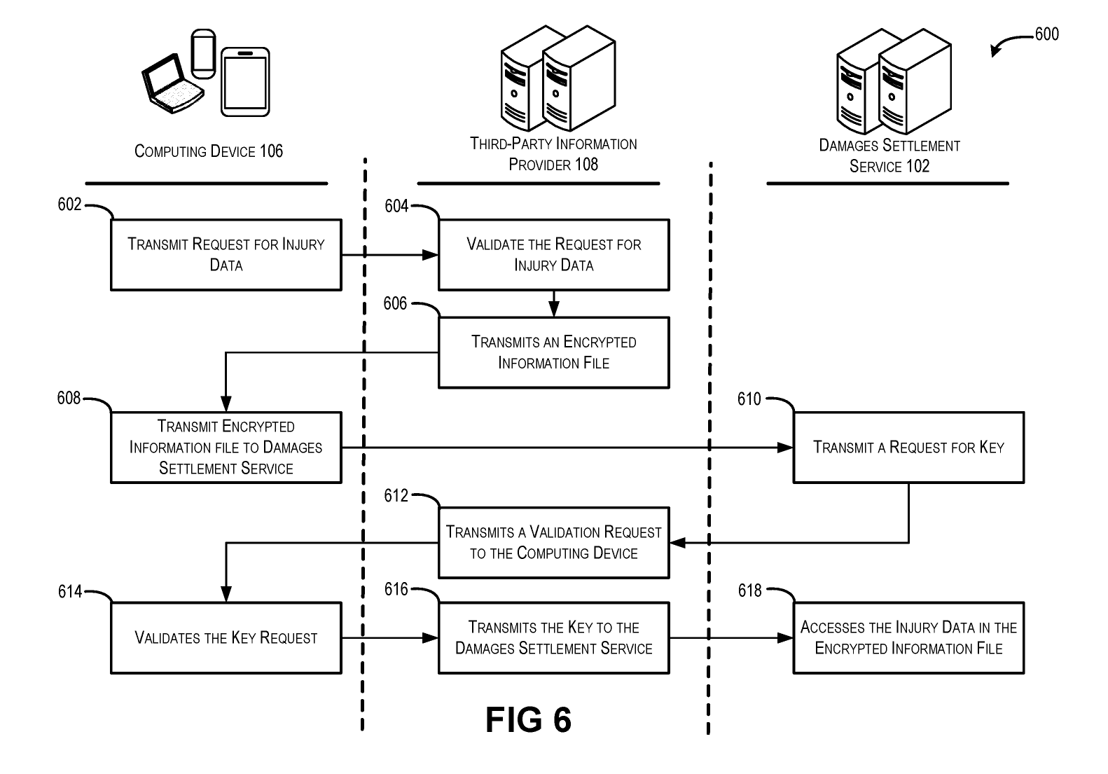

FIG. 1A further illustrates the one or more third party information providers 108 as including injury data 116 and a security module 118. The third party information providers 108 may be associated with institutions or services that provide accident information associated with the injured party 104. For example, a third-party information provider may include a police department traffic division and/or an insurance investigation depai iment that evaluates accidents and generates injury data 116 (e.g., accident reports) that include accident information associated with the injured party 104. A third-party information provider may also include a doctor's office and/or hospital that examines an injured party 104 and generates injury data 116 (e.g., medical records) that include accident information associated with the injured party 104. Injury data 116 may include factual traits associated with the injured party 104 (e.g., description of an accident, cause of injury, severity of injury, location of accident, type of injury, traits of injured party, fault of injured and/or other party(s), parties involved in the accident, etc.) The security module 118 may enable the third-party information provider 108 to store and share injury data 116 in a way that protects confidentiality and/or fidelity of the injury data 116. For example, the security module 118 may restrict access of damages settlement service 102 to a portion of injury data 116 that is relevant to securing a settlement estimation for an injured party 104. Alternatively, or in addition, the security module 118 may transmit injury data 118 to the damages settlement service 102 and/or defendant insurers 110 using secure connections, data encryption techniques, data fingerprinting, or other techniques for ensuring that the injury data 116 is not tampered with and/or disseminated to unintended entities. For example, a third-party information providers 108 may provide an encrypted file containing injury data to a computing device 106 associated with an injured party or damages settlement service 102, and may separately transmit a key for accessing the encrypted file in response to verification that the entity requesting the key is authorized to access the injury date 116. The security module 118 may go through one or more security protocols to ensure that the requesting party is authorized to receive the key, such as those described below in relation to FIG. 6.

FIG. 1A further illustrates a process for efficiently securing optimal settlements for injured parties. For example, FIG. 1A shows damages settlement service 102 receiving injury data 116 from one or more computing device 106 associated with an injured party 104. In some embodiments, the damages settlement service 102 may receive the injury data 116 via email, text, SMS, a web interface, application module, kiosk, or other means for passing injury data 116 between computing device 106 and damages settlement service 102. Alternatively, or in addition, injury data 116 may be entered directly into the damages settlement service 102 via one or more user interfaces (e.g., keyboards, touchscreens, kiosks, etc.), or may be received from one or more third-party information providers 108 associated with the injured party 104. For example, the damages settlement service 102 may operate one or more computer kiosks through which an injured party 104 can request services from the damages settlement service 102, input injury data 116, authorize the damages settlement service 102 to acquire injury data, review settlement packages 124 or settlement offers 128, or a combination thereof. A kiosk may be a computing station that includes a display, and one or more interfaces for interacting with and/or inputting injury data 116 into the kiosk (e.g., keyboard, touchscreen, barcode scanner, camera, USB/HDMI/other computing port for connecting devices, wireless or network interfaces, etc.).

In some embodiments, damages settlement service 102 may transmit a record request 120 to a third-party information provider 108. The record request 120 may include one or more identifiers or keys associated with the injured party 104, and a request to access information associated with the injured party 104. The damages settlement service 102 may receive an identifier or key from the injured party 104, and may securely access injury data 116 via a third-party information provider 108 by including the identifier and/or key in a record request 120 submitted to the third-party information provider 108. For example, the damages settlement service 102 may transmit a request for an accident report to a traffic accident investigation division of a police department, where the request includes an identifier associated with a police report relating to an accident involving the injured party 104, and a request for a copy of and/or information included in the police report.

The security module 118 may then access a permission rules associated with the injury data 116 to identify portions of the injury data 116 that are to be shared with damages settlement service 102. In some embodiments, permission rules may be established by the injured party 104, the third-party information providers 108, or a combination thereof. For example, where the third-party information provider 108 is a hospital, and the requested injury data 116 is located in the injured party's 104 medical history, the security module 118 may only authorize the injury data 116 to be accessed if the injured party 104 has authorized some or all of their medical records to be shared with the damages settlement service 102.

Alternatively, or in addition, the security module 118 may transmit a notification to a computing device 106 that notifies the injured party 104 that the damages settlement service 102 is trying to access his or her personal information. The notification may identify the entity requesting the personal information, and/or include a selectable option to authorize the third-party information provider to provide the personal information to the entity. Alternatively, or in addition, the notification may include data that causes the computing device 106 to launch an application associated with the security module 118, where the application may present information relating to the requesting entity and/or information being requested, may include functionality for authorizing the third-party information provider to provide the personal information to the entity, or a combination thereof. In some embodiments, the notification may be transmitted by one or more mediums such as WiFi-based communication such as via frequencies defined by the IEEE 802.11 standards, short range wireless frequencies such as Bluetooth®, or any suitable wired or wireless communications protocol that enables the respective computing device to interface with the other computing devices (e.g., telephone networks). In this way, the injured party 104 may receive the notification that an entity is trying to access its personal data even when his or her computing device 106 is not connected to the internet and/or an application associated with the security module 118 is not open/being viewed by the injured party 104.

Once the damages settlement service 102 has acquired the injury data 116 associated with the injured party 104, the damages settlement service 102 may utilize the historical settlement information stored in the settlement data store 112 to determine an estimated value of an injury settlement for an injured party 104. For example, the estimation service 114 may compare the injury data 116 associated with the injured party 104 to historical settlement information stored in the settlement data store 112 to identify one or more settlement amounts that injuries with similar accident information settled for, and then estimate a settlement range that would likely represent fair compensation for the injured party's 104 damages. In some embodiments, the estimate package 122 may indicate a level of similarity between the injured party's injury and the injury associated with an individual historical settlement. When generating the estimation of the settlement range that would likely represent fair value, the damages element service 102 may compare the level of similarities for corresponding to individual historical settlements to a threshold value. In some embodiments, the damages settlement service may generate the estimation the settlement range based on historical settlements whose level of similarity meet or exceed the threshold value.

The damages settlement service 102 may then generate and provide an estimate package 122 to the computing devices 106 associated with the injured party 104. The estimate package 122 may include the value range that the damages settlement service 102 estimates to be fair value for the injured party's 104 claim, and/or a list identifying and describing information about similar historical settlements. The estimate package 122 may also include a confidence value relating to a probability that the estimated range is a fair value for the injured party's 104 claim. For example, where the settlement data store 112 includes a set of historical settlements that have very similar facts, and the set of historical settlements each settled within a small value range, the settlement data store 112 may indicate a high degree of confidence that the estimated range is an accurate estimate of fair value.

The estimate package 122 may also include a recommendation of whether the injured party 104 should obtain legal assistance, and/or an estimated value that acquiring legal assistance would likely provide to the injured party 104. For example, the damages settlement service 102 may determine average settlement ranges for a first set of similar cases in which the injured party obtained legal assistance and a second set of similar cases in which the injured party did not obtain legal assistance. In some embodiments, where the damages settlement service 102 determines that the settlement ranges for the first set of cases is greater than the settlement ranges for the second set of cases, and/or that the increased value for obtaining legal assistance in similar cases is greater than or equal to a threshold value (e.g., a set amount, a percentage amount, etc.), the damages settlement service 102 may cause the estimate package to include a recommendation that the injured party 104 consider obtaining legal assistance.

The damages settlement service 102 may then generate and provide a settlement package 124 to the defendant insurer 108. The settlement package 124 may include some or all of the information included in the estimate package 122, such as the estimated range of fair value, similar historical settlements, the confidence value for the estimated range, suggestion to get an attorney, etc. The settlement package 124 may also include an estimated value of the injured party's injury. The estimated value 124 may be determined by the damages settlement service, or selected by another entity, such as the injured party 104.

In some embodiments, the defendant insurer 110 may submit one or more verification request 126 to third-party information providers 108 to verify the validity of the estimated value of the injured party's injury and/or the injury data that the determination of the estimated value was based upon. The verification request may include one or more identifiers and/or keys that identify the desired injury data 116 and/or authorize the defendant insurers 110 to access the desired injury data. The defendant insurers 110 may then transmit a settlement offer 128 to the damages settlement service, the injured party 104, or both. Based on the settlement offer 128, the damages settlement service 102 may provide recommendations that the injured party 104 accept the settlement offer, make a counter offer, and/or obtain legal assistance.

FIG. 1A also illustrates third-party accident identification sources 130. Third-party accident identifications sources 130 may be entities or sources that provide accident identification data 132 to the damages settlement service 102. For example, a third-party accident identifications source 130 may include news media sources (websites, blogs, social media accounts, etc.), publicly available records (e.g., arrest records), police department sources (e.g., police scanners, websites, social media accounts, accident reports, press releases, department publications, etc.), social media sources (e.g., blogs, microblogs, posts, webpages, streams, etc.), public sensors (e.g., public traffic cameras), insurance company sources, reports of accidents by participants of the accidents, witnesses of the accidents, other motorist, tow truck drivers, body shops, (e.g., via a website, email, blog, application, widget, etc.), or other third party sources.

The accident identification data 132 may include information that identifies one or more of the location of an accident, participants in an accident, descriptions of an accident, video/audio of the accident, witnesses of the accident, severity of the accident, damages/injuries caused by the accident, or other information associated with an accident. The damages settlement service 102 may receive the accident identification data 132 by crawling or otherwise monitoring a web presence of a third-party accident identification source 130, receiving updates, messages, emails, or other notifications from third-party accident identification sources 130, by accessing physical or digital publications (e.g., traffic reports, accident reports, blog posts, microblog posts, etc.) put out by a third-party accident identification source 130, accessing publicly available data sources (e.g., police scanners, radio station reports, public traffic cameras, traffic congestion monitors, crowd sourced traffic/accident services, etc.) associated with third-party accident identification sources 130, from submissions via one or more widgets, websites, applications, API's, or other digital interfaces that can transmit information from the third-party accident identification sources 130 to the damages settlement service 102, etc. For example, the damages settlement service 102 may identify, crawl, receive updates, monitor, or otherwise pull information about an accident from a news media account, social media account, website post, or other publication of the accident published by a news media entity. In another example, the damages settlement service 102 may receive information about an accident from tow truck drivers, police departments, or body shops that submit accident identification data into an application associated with the damages settlement service.

In some embodiments, the damages settlement server 102 may use information derived from the accident identification data 132 to identify injured party 104, and may solicit or otherwise provide recommendations (e.g., advertisements, emails, etc.) that the injured party 104 seek or acquire settlement services from damages settlement service 102. In some embodiments, the damages settlement server 102 may use information derived from the accident identification data 132, either in combination with or independent of injury data 116, when the generating of settlement packages 124. For example, the damages settlement server 102 may use information derived from the accident identification data 132 to identify historical accidents that are similar to the accident described by the accident identification data 132. In some embodiments, the solicitations and/or recommendations may include a sample estimate package 122 that the injured party 104 could expect to receive if they use damages services from the damages settlement service 102. The sample estimate package may be generated using information included in accident identification data 132, and may identify similar accidents, an estimated range of settlement, or other information. The sample estimate package may also include notices that the estimated range of settlement may increase once additional injury data 116 is obtained and utilized by the damages settlement service 102.

FIG. 1A further illustrates each of the damages settlement service 102, one or more computing devices 106, one or more third-party information providers 108, defendant insurer 110, and third party accident identification sources 130 as being connected to a network 134.

FIG. 1B is a schematic diagram of an illustrative environment 150 for efficiently securing optimal settlements for injured parties using a third-party settlement estimation service. The environment 150 includes damages settlement service 102, injured party 104, and one or more computing devices 106 associated with the injured party 104. Environment 150 further includes one or more third-party information providers 108, defendant insurer 110, and a third-party estimation service 152. Third-party estimation service 152 may correspond to one or more service providers that generate value estimation services for injuries (e.g., Colossus.

The damages settlement service 102, one or more computing devices 106, one or more third-party information providers 108, defendant insurer 110, and third-party estimation service 152 may each include any combination of one or more types of computing devices such as laptop computers, personal computers, voice controlled computing devices, tablet devices, mobile telephones, server(s), platforms, etc. Any such device may include one or more processor(s), computer-readable media, speakers, a display, etc.

FIG. 1B further illustrates damages settlement service 102 as including an injury data accumulator 154 and an estimate package generator 156. The data accumulator 154 may enable the damages settlement service 102 to compile injury data 116 associated with the injured party 104 from one or more sources. For example, injury data accumulator 154 may generate and provide a graphical user interface (GUI) that is configured to receive inputs of injury data 116 to injured party device 106. Alternatively, or in addition, the injury data accumulator 154 may transmit a record request 120 to a third-party information provider 108. The record request 120 may include one or more identifiers or keys associated with the injured party 104, and a request to access information associated with the injured party 104. The data accumulator 154 may receive an identifier or key from the injured party 104 (e.g., via the GUI), and may securely access injury data 116 via a third-party information provider 108 by including the identifier and/or key in a record request 120 submitted to the third-party information provider 108. For example, the data accumulator 154 may transmit a request for an accident report to a traffic accident investigation division of a police department, where the request includes an identifier associated with a police report relating to an accident involving the injured party 104, and a request for a copy of and/or information included in the police report. The data accumulator 154 may then automatically compile injury data 116 from the one or more sources.

The estimate package generator 156 may enable the damages settlement service 102 to generate an estimate package 122. In some embodiments, the estimate package 122 may be generated based at least in part on a value estimate 158 received from third-party estimation service 152. The estimate package 122 may include the value range that the damages settlement service 102 estimates to be fair value for the injured party's 104 claim, a list identifying and describing information about similar historical settlements, one or more indications of a level of similarity between the injured party's injury and the individual historical settlements, a confidence value relating to a probability that the estimated range is a fair value for the injured party's 104 claim, etc.

FIG. 1B further illustrates the one or more third party information providers 108 as including injury data 116 and a security module 118. The third-party information providers 108 may be associated with institutions or services that provide accident information associated with the injured party 104. For example, a third-party information provider may include a police department traffic division and/or an insurance investigation depai iment that evaluates accidents and generates injury data 116 (e.g., accident reports) that include accident information associated with the injured party 104. A third-party information provider may also include a doctor's office and/or hospital that examines an injured party 104 and generates injury data 116 (e.g., medical records) that include accident information associated with the injured party 104. Injury data 116 may include factual traits associated with the injured party 104 (e.g., description of an accident, cause of injury, severity of injury, location of accident, type of injury, traits of injured party, fault of injured and/or other party(s), parties involved in the accident, etc.) The security module 118 may enable the third-party information provider 108 to store and share injury data 116 in a way that protects confidentiality and/or fidelity of the injury data 116. For example, the security module 118 may restrict access of damages settlement service 102 to a portion of injury data 116 that is relevant to securing a settlement estimation for an injured party 104. Alternatively, or in addition, the security module 118 may transmit injury data 118 to the damages settlement service 102 and/or defendant insurers 110 using secure connections, data encryption techniques, data fingerprinting, blockchain cryptography, or other techniques for ensuring that the injury data 116 is not tampered with and/or disseminated to unintended entities.

FIG. 1B further illustrates third-party estimation service 152 as including settlement data store 112 and an estimation service 114. The settlement data store 112 may be a database that contains historical settlement information associated with the previous injury settlements between injured parties 104 and defendant insurers 110. For example, settlement data store 112 may identify the settlement value of individual settlements (e.g., how much the injured party received as compensation), factual traits of individual settlements (e.g., description of accident, cause of injury, severity of injury, location of accident, type of injury, traits of injured party, parties involved in the accident, fault of injured and/or other party(s), whether an attorney/representative was involved, etc.), timelines of settlements, and/or other information relating to previous settlements between injured parties and insurance companies.

The estimation service 114 may enable the third-party estimation service 152 to utilize the historical settlement information stored in the settlement data store 112 to determine an estimated value of an injury settlement for an injured party 104. For example, the estimation service 114 may compare accident information associated with an injured party 104 to historical settlement information stored in the settlement data store 112 to identify one or more settlement amounts that injuries with similar accident information settled for, and then estimate a settlement range that would likely represent fair compensation for the injured party's 104 damages.

FIG. 1B further illustrates a process for efficiently securing optimal settlements for injured parties using a third-party estimation service 152. For example, FIG. 1B shows damages settlement service 102 receiving injury data 116 from one or more computing device 106 associated with an injured party 104. In some embodiments, the damages settlement service 102 may receive the injury data 116 via email, text, SMS, a web interface, application module, or other means for passing injury data 116 between computing device 106 and damages settlement service 102. Alternatively, or in addition, injury data 116 may be entered directly into the damages settlement service 102 via one or more user interfaces (e.g., keyboards, touchscreens, etc.), or may be received from one or more third-party information providers 108 associated with the injured party 104.

In some embodiments, damages settlement service 102 may transmit a record request 120 to a third-party information provider 108. The record request 120 may include one or more identifiers or keys associated with the injured party 104, and a request to access information associated with the injured party 104. The damages settlement service 102 may receive an identifier or key from the injured party 104, and may securely access injury data 116 via a third-party information provider 108 by including the identifier and/or key in a record request 120 submitted to the third-party information provider 108. For example, the damages settlement service 102 may transmit a request for an accident report to a traffic accident investigation division of a police department, where the request includes an identifier associated with a police report relating to an accident involving the injured party 104, and a request for a copy of and/or information included in the police report.

The security module 118 may then access a permission rules associated with the injury data 116 to identify portions of the injury data 116 that are to be shared with damages settlement service 102. In some embodiments, permission rules may be established by the injured party 104, the third-party information providers 108, or a combination thereof. For example, where the third-party information provider 108 is a hospital, and the requested injury data 116 is located in the injured party's 104 medical history, the security module 118 may only authorize the injury data 116 to be accessed if the injured party 104 has authorized some or all of their medical records to be shared with the damages settlement service 102.

Once the damages settlement service 102 has acquired the injury data 116 associated with the injured party 104, the damages settlement service 102 may transmit the accumulated injury data 116 to the third-party estimation service 152. The third-party estimation service may utilize the historical settlement information stored in the settlement data store 112 to determine an estimated value of an injury settlement for an injured party 104. For example, the estimation service 114 may compare the injury data 116 associated with the injured party 104 to historical settlement information stored in the settlement data store 112 to identify one or more settlement amounts that injuries with similar accident information settled for, and then estimate a settlement range that would likely represent fair compensation for the injured party's 104 damages. The third-party estimation service 152 may then transmit a value estimate 158 to the damages settlement service 102. The value estimate 158 may include information such as the estimated range of fair value, similar historical settlements, the confidence value for the estimated range, suggestion to get an attorney, etc.

The damages settlement service 102 may then generate an estimate package 122 based on the value estimate 158, and provide the estimate package 122 to the computing devices 106 associated with the injured party 104. The estimate package 122 may include the value range that the damages settlement service 102 estimates to be fair value for the injured party's 104 claim, and/or a list identifying and describing information about similar historical settlements. In some embodiments, the estimate package 122 may indicate a level of similarity between the injured party's injury and the injury associated with an individual historical settlement. The estimate package 122 may also include a confidence value relating to a probability that the estimated range is a fair value for the injured party's 104 claim. For example, where the settlement data store 112 includes a set of historical settlements that have very similar facts, and the set of historical settlements each settled within a small value range, the settlement data store 112 may indicate a high degree of confidence that the estimated range is an accurate estimate of fair value.

The estimate package 122 may also include a recommendation of whether the injured party 104 should obtain legal assistance, and/or an estimated value that acquiring legal assistance would likely provide to the injured party 104. For example, the damages settlement service 102 may determine average settlement ranges for a first set of similar cases in which the injured party obtained legal assistance and a second set of similar cases in which the injured party did not obtain legal assistance. In some embodiments, where the damages settlement service 102 determines that the settlement ranges for the first set of cases is greater than the settlement ranges for the second set of cases, and/or that the increased value for obtaining legal assistance in similar cases is greater than or equal to a threshold value (e.g., a set amount, a percentage amount, etc.), the damages settlement service 102 may cause the estimate package to include a recommendation that the injured party 104 consider obtaining legal assistance.

The damages settlement service 102 may then generate and provide a settlement package 124 to the defendant insurer 108. The settlement package 124 may include some or all of the information included in the estimate package 122, such as the estimated range of fair value, similar historical settlements, the confidence value for the estimated range, suggestion to get an attorney, etc. The settlement package 124 may also include an estimated value of the injured party's injury. The estimated value 124 may be determined by the damages settlement service, or selected by another entity, such as the injured party 104.

In some embodiments, the defendant insurer 110 may submit one or more verification request 126 to third-party information providers and/or the third-party estimation service 152 to verify the validity of the estimated value of the injured party's injury and/or the injury data that the determination of the estimated value was based upon. The verification request may include one or more identifiers and/or keys that identify the desired injury data 116 and/or authorize the defendant insurers 110 to access the desired injury data. The defendant insurers 110 may then transmit a settlement offer 128 to the damages settlement service, the injured party 104, or both. Based on the settlement offer 128, the damages settlement service 102 may provide recommendations that the injured party 104 accept the settlement offer, make a counter offer, and/or obtain legal assistance.

While FIG. 1B does not illustrate third-party accident identification sources 130, it may be utilized by the damages settlement service 102 described in the illustrative environment 150. Third-party accident identifications sources 130 may be entities or sources that provide accident identification data 132 to the damages settlement service 102. The accident identification data 132 may include information that identifies one or more of the location of an accident, participants in an accident, descriptions of an accident, video/audio of the accident, witnesses of the accident, severity of the accident, damages/injuries caused by the accident, or other information associated with an accident.

In some embodiments, the damages settlement server 102 may use information derived from the accident identification data 132 to identify injured party 104, and may solicit or otherwise provide recommendations (e.g., advertisements, emails, etc.) that the injured party 104 seek or acquire settlement services from damages settlement service 102. In some embodiments, the solicitations and/or recommendations may include a sample estimate package 122 that the injured party 104 could expect to receive if they use damages services from the damages settlement service 102. The sample estimate package may identify similar accidents, an estimated range of settlement, or other information. The sample estimate package may also include notices that the estimated range of settlement may increase once additional injury data 116 is obtained and utilized by the damages settlement service 102. In some embodiments, the damages settlement server 102 may submit information derived from the accident identification data 132, either in combination with or independent of injury data 116, to third-party estimate generator 152 for the generation of sample estimate packages.

FIG. 1B further illustrates each of the damages settlement service 102, one or more computing devices 106, one or more third-party information providers 108, defendant insurer 110, and third-party estimation service 152 as being connected to a network 134.

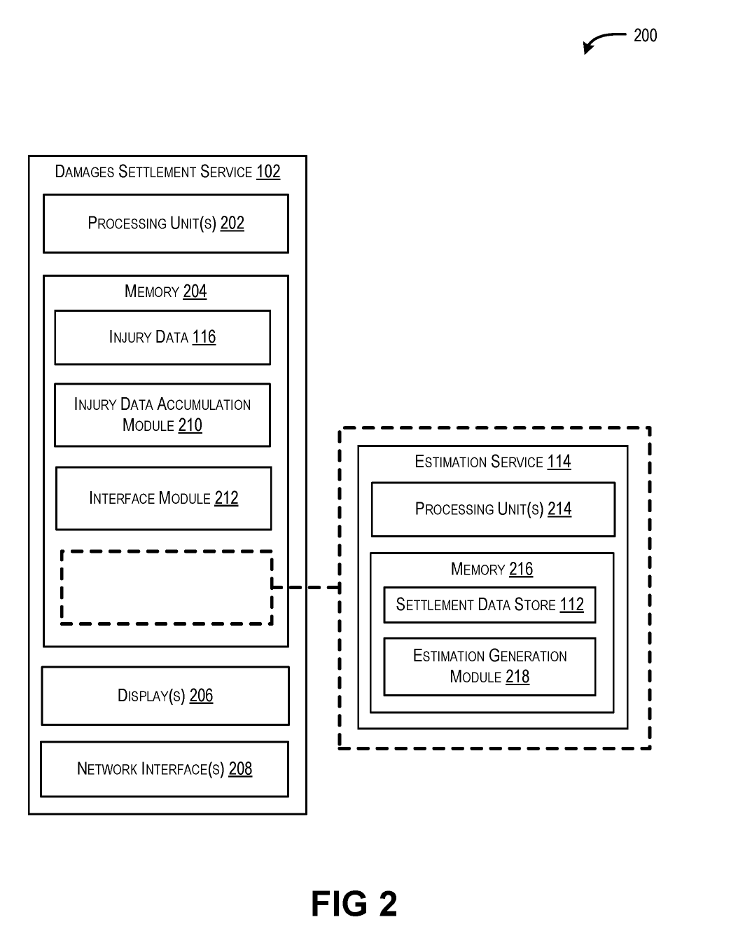

FIG. 2 is an illustrative computing architecture 200 of a computing device configured to efficiently secure optimal settlements for injured parties. The computing architecture 200 may be used to implement the various systems, devices, and techniques discussed herein. In various embodiments, damages settlement service 102 may be implemented on any type of device, such as laptop computers, personal computers, voice controlled computing devices, tablet devices, mobile telephones, server(s), platforms, etc.

In the illustrated implementation, the computing architecture 200 includes one or more processing units 202 coupled to a memory 204. The computing architecture may also include a display 206 and/or network interface 208. FIG. 2 further estimation service 114 as being separate from the damages settlement service 102. However, in some embodiments the estimation service 114 may be incorporated as a component of the damages settlement service 102, or vice versa.

The damages settlement service 102 can include an injury data 116 stored on the memory 204. The injury data 116 store be a database that contains injury data 116. Injury data 116 may include factual traits associated with the injured party 104. For example, injury data 116 may include one or more of a description of an accident, cause of injury, severity of injury, location of accident, type of injury, traits of injured party, fault of injured and/or other party(s), parties involved in the accident, or other information that describes an injury to an injured party 104.

The damages settlement service 102 can also include an injury data accumulation module 210 and an interface module 212. As used herein, the term “module” is intended to represent example divisions of executable instructions for purposes of discussion, and is not intended to represent any type of requirement or required method, manner or organization. Accordingly, while various “modules” are described, their functionality and/or similar functionality could be arranged differently (e.g., combined into a fewer number of modules, broken into a larger number of modules, etc.). Further, while certain functions and modules are described herein as being implemented by software and/or firmware executable on a processor, in other instances, any or all of the modules can be implemented in whole or in part by hardware (e.g., a specialized processing unit, etc.) to execute the described functions. In various implementations, the modules described herein in association with damages settlement service 102 can be executed across multiple devices.

The injury data accumulation module 210 can be executable by the one or more processing units 202 to receive or otherwise acquire injury data 116. In some embodiments, the injury data accumulation module 210 may enable the damages settlement service 102 to compile injury data 116 associated with an injured party 104 from one or more sources. Alternatively, or in addition, the injury data accumulation module 210 may transmit a record request 120 to a third-party information provider 108. The record request 120 may include one or more identifiers or keys associated with the injured party 104, and a request to access information associated with the injured party 104. The injury data accumulation module 210 may receive an identifier or key from the injured party 104 (e.g., via the GUI), and may securely access injury data 116 via a third-party information provider 108 by including the identifier and/or key in a record request 120 submitted to the third-party information provider 108. For example, the injury data accumulation module 210 may transmit a request for an accident report to a traffic accident investigation division of a police department, where the request includes an identifier associated with a police report relating to an accident involving the injured party 104, and a request for a copy of and/or information included in the police report. The injury data accumulation module 210 may then automatically compile injury data 116 from the one or more sources.

The interface module 212 may also generate interfaces that enable the damages settlement service 102 to receive interactions from injured parties 104, third party information providers 108, third-party estimation services 152, etc. For example, interface module 212 may generate and provide a graphical user interface (GUI) that is configured to receive inputs of injury data 116 to injured party device 106. The interface module 212 may receive value estimates from the estimation service 114 and generate an estimate package 122 to provide to one or more of the injured party 104 and defendant insurers 110. For example, the estimate package 122 may be an interface that includes a value range that the damages settlement service 102 estimates to be fair value for the injured party's 104 claim, and/or a list identifying and describing information about similar historical settlements. In some embodiments, the estimate package 122 may include one or more indications of a level of similarity between the injured party's injury and the injury associated with an individual historical settlement, one or more confidence values relating to a probability that the estimated range is a fair value for the injured party's 104 claim, a recommendation of whether the injured party 104 should obtain legal assistance, an estimated value that acquiring legal assistance would likely provide to the injured party 104, or a combination thereof

Alternatively, or in addition, the interface module 212 generate and provide a settlement package 124 to the defendant insurer 108. In some embodiments, the settlement package 124 may be an interface that includes some or all of the information included in the estimate package 122, such as the estimated range of fair value, similar historical settlements, the confidence value for the estimated range, suggestion to get an attorney, an estimated value of the injured party's injury, etc.

FIG. 2 further depicts estimation service 114. Estimation service 114 may be a component of damages settlement service 102, or may be independently hosted by a third-party service (e.g., third-party estimation service 152). In some embodiments, estimation service 114 may further include processing unit(s) 214, and memory 216. The estimation service 114 can include a settlement data store 112 and estimation generation module 218 stored on the memory 216. The settlement data store 112 may be a database that contains historical settlement information associated with the previous injury settlements between injured parties 104 and defendant insurers 110. For example, settlement data store 112 may identify the settlement value of individual settlements (e.g., how much the injured party received as compensation), factual traits of individual settlements (e.g., description of accident, cause of injury, severity of injury, location of accident, type of injury, traits of injured party, parties involved in the accident, fault of injured and/or other party(s), whether an attorney/representative was involved, etc.), timelines of settlements, and/or other information relating to previous settlements between injured parties and insurance companies.

The estimation generation module 218 can be executable by the one or more processing units 214 to utilize the historical settlement information stored in the settlement data store 112 to determine an estimated value of an injury settlement for an injured party 104. For example, the estimation generation module 218 may compare accident information associated with an injured party 104 to historical settlement information stored in the settlement data store 112 to identify one or more settlement amounts that injuries with similar accident information settled for, and then estimate a settlement range that would likely represent fair compensation for the injured party's 104 damages.

The one or more processing unit(s) 202 and 214 may be configured to execute instructions, applications, or programs stored in the memory(s) 204 and 218. In some examples, the one or more processing unit(s) 202 and 214 may include hardware processors that include, without limitation, a hardware central processing unit (CPU), a graphics processing unit (GPU), and so on. While in many instances the techniques are described herein as being performed by the one or more processing unit(s) 202 and 214, in some instances the techniques may be implemented by one or more hardware logic components, such as a field programmable gate array (FPGA), a complex programmable logic device (CPLD), an application specific integrated circuit (ASIC), a system-on-chip (SoC), or a combination thereof.

The memory 204 and 218 is an example of computer-readable media. Computer-readable media may include two types of computer-readable media, namely computer storage media and communication media. Computer storage media may include volatile and non-volatile, removable, and non-removable media implemented in any method or technology for storage of information, such as computer readable instructions, data structures, program modules, or other data. Computer storage media includes, but is not limited to, random access memory (RAM), read-only memory (ROM), erasable programmable read-only memory (EEPROM), flash memory or other memory technology, compact disc read-only memory (CD-ROM), digital versatile disk (DVD), or other optical storage, magnetic cassettes, magnetic tape, magnetic disk storage or other magnetic storage devices, or any other non-transmission medium that may be used to store the desired information and which may be accessed by a computing device. In general, computer storage media may include computer-executable instructions that, when executed by one or more processing units, cause various functions and/or operations described herein to be performed.

Additionally, a computer media includes data stored within a modulated data signal. For example, a computer media may include computer readable instructions, data structures, program modules, modulated carrier waves, other modulated transmission mechanisms, etc. However, as defined herein, computer storage media does not include communication media. Those skilled in the art will also appreciate that, while various items are illustrated as being stored in memory or storage while being used, these items or portions of them may be transferred between memory and other storage devices for purposes of memory management and data integrity. Alternatively, in other implementations, some or all of the software components may execute in memory on another device and communicate with the illustrated environment 200. Some or all of the system components or data structures may also be stored (e.g., as instructions or structured data) on a non-transitory, computer-accessible medium or a portable article to be read by an appropriate drive, various examples of which are described above. In some implementations, instructions stored on a computer-accessible medium separate from damages settlement service 102 and/or estimation service 114 may be transmitted to damages settlement service 102, and/or estimations service 114 via transmission media or signals such as electrical, electromagnetic, or digital signals, conveyed via a communication medium such as a wireless link. Various implementations may further include receiving, sending or storing instructions and/or data implemented in accordance with the foregoing description upon a computer-accessible medium.

Additionally, the network interface 208 includes physical and/or logical interfaces for connecting the respective computing device(s) to another computing device or network. For example, the network interface 208 may enable WiFi-based communication such as via frequencies defined by the IEEE 802.11 standards, short range wireless frequencies such as Bluetooth®, or any suitable wired or wireless communications protocol that enables the respective computing device to interface with the other computing devices.

The architectures, systems, and individual elements described herein may include many other logical, programmatic, and physical components, of which those shown in the accompanying figures are merely examples that are related to the discussion herein.

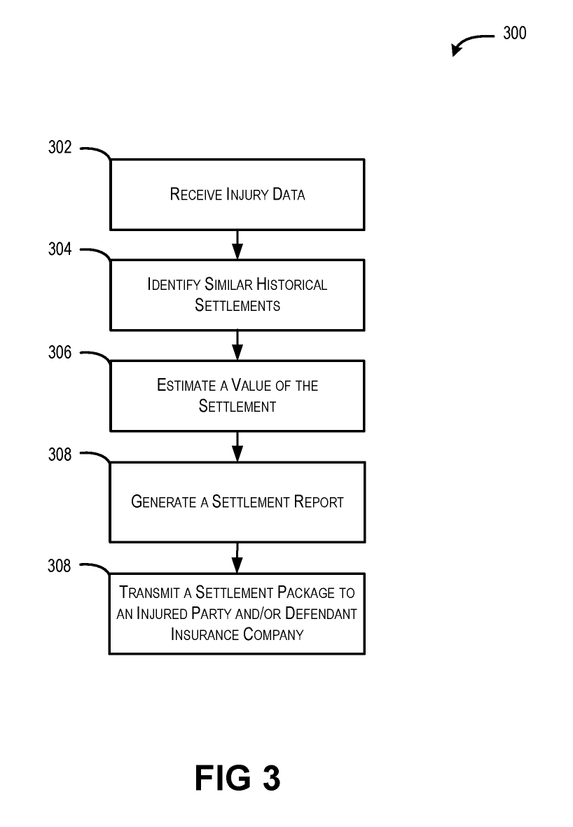

FIGS. 3, 4, and 5 are flow diagrams of illustrative processes illustrated as a collection of blocks in a logical flow graph, which represent a sequence of operations that can be implemented in hardware, software, or a combination thereof. The blocks are organized under entities and/or devices that may implement operations described in the blocks. However, other entities/devices may implement some blocks. In the context of software, the blocks represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described blocks can be combined in any order and/or in parallel to implement the processes.

FIG. 3 is a flow diagram of an illustrative process 300 for efficiently securing optimal settlements for injured parties. The process 300 may be implemented by the computing architecture 200 and in the environment 100 described above, or in other environments and architectures.

At 302, damages settlement service 102 receives injury data. In some embodiments, damages settlement service 102 may receive injury data 116 from one or more computing device 106 associated with an injured party 104. In some embodiments, the damages settlement service 102 may receive the injury data 116 via email, text, SMS, a web interface, application module, or other means for passing injury data 116 between computing device 106 and damages settlement service 102. Alternatively, or in addition, injury data 116 may be entered directly into the damages settlement service 102 via one or more user interfaces (e.g., keyboards, touchscreens, etc.), or may be received from one or more third-party information providers 108 associated with the injured party 104. In some embodiments, damages settlement service 102 may transmit a record request to a third-party information provider 108. The record request may include one or more identifiers or keys associated with the injured party 104, and a request to access information associated with the injured party 104. The damages settlement service 102 may receive an identifier or key from the injured party 104, and may securely access injury data 116 via a third-party information provider 108 by including the identifier and/or key in a record request 120 submitted to the third-party information provider 108.

At 304, the damages settlement service 102 identifies similar historical settlements. In some embodiments, damages settlement service 102 may utilize the historical settlement information stored in the settlement data store 112 to determine an estimated value of an injury settlement for an injured party 104. For example, the damages settlement service 102 may compare the injury data 116 associated with the injured party 104 to historical settlement information stored in the settlement data store 112 to identify one or more settlement amounts that injuries with similar accident information settled for.

At 306, damages settlement service 102 estimates a value of the settlement. The defendant insurer 110 may estimate a settlement range that would likely represent fair compensation for the injured party's 104 damages. In some embodiments, the damages settlement service 102 may utilize the historical settlement information stored in the settlement data store 112 to determine an estimated value of an injury settlement for an injured party 104. The damages settlement service 102 may also determine average settlement ranges for a first set of similar cases in which the injured party obtained legal assistance and a second set of similar cases in which the injured party did not obtain legal assistance. In some embodiments, estimating the value of the settlement may include evaluating the injured party's 104 damages using an evaluation formula based on historical settlement information.

At 308, damages settlement service 102 generates a settlement report. The settlement report may include the value range that the damages settlement service 102 estimates to be fair value for the injured party's 104 claim, and/or a list identifying and describing information about similar historical settlements. In some embodiments, the settlement report may indicate a level of similarity between the injured party's injury and the injury associated with an individual historical settlement. The settlement report may also include a confidence value relating to a probability that the estimated range is a fair value for the injured party's 104 claim. For example, damages settlement service 102 determines that the similar historical settlements have each settled within a small value range, the settlement report may indicate a high degree of confidence that the estimated range is an accurate estimate of fair value.

At 310, damages settlement service 102 transmits a settlement package to an injured party and/or defendant insurance company. The defendant insurer 110 may verify the validity of the estimated value of the injured party's injury in the settlement report. The defendant insurers 110 may then transmit a settlement offer to the damages settlement service, the injured party 104, or both.

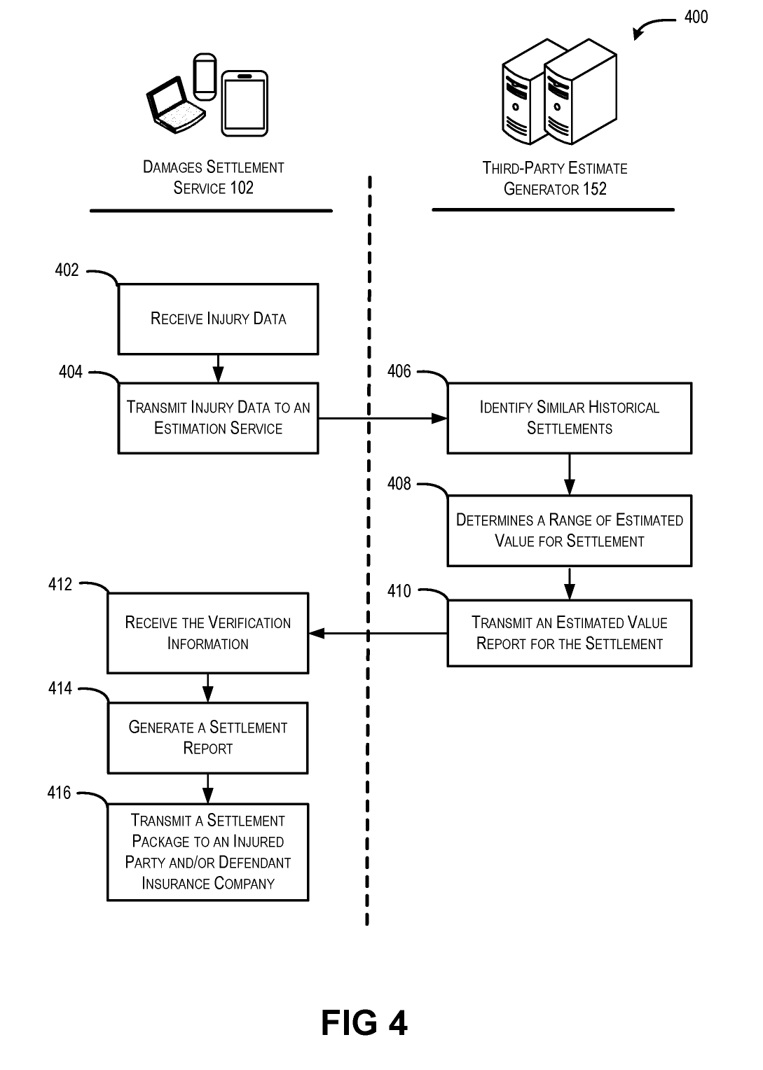

FIG. 4 is a flow diagram of an illustrative process 400 for using a third-party estimation service to efficiently secure optimal settlements for injured parties. The process 400 may be implemented by the computing architecture 200 and in the environment 100 described above, or in other environments and architectures.

At 402, damages settlement service 102 receives injury data. In some embodiments, damages settlement service 102 may receive injury data 116 from one or more computing device 106 associated with an injured party 104. In some embodiments, the damages settlement service 102 may receive the injury data 116 via email, text, SMS, a web interface, application module, or other means for passing injury data 116 between computing device 106 and damages settlement service 102. Alternatively, or in addition, injury data 116 may be entered directly into the damages settlement service 102 via one or more user interfaces (e.g., keyboards, touchscreens, etc.), or may be received from one or more third-party information providers 108 associated with the injured party 104. In some embodiments, damages settlement service 102 may transmit a record request to a third-party information provider 108. The record request may include one or more identifiers or keys associated with the injured party 104, and a request to access information associated with the injured party 104. The damages settlement service 102 may receive an identifier or key from the injured party 104, and may securely access injury data 116 via a third-party information provider 108 by including the identifier and/or key in a record request 120 submitted to the third-party information provider 108.

At 404, the damages settlement service 102 the damages settlement service 102 transmits injury data to an estimate service. In some embodiments, the estimate service may be a third-party estimate generator that stores historic settlement data, and estimates the likely value of injury settlements based on the historic data.

At 406, the estimate service identifies similar historical settlements. In some embodiments, the estimate service may identify historical settlements cases that are similar to the injury data, and determine a range of values that the historically similar cases settled at.

For example, the estimate service may compare the injury data 116 associated with the injured party 104 to historical settlement information locally stored by the estimate service, and identify a set of settlement amounts that injuries with similar accident information settled for, and then estimate a settlement range that would likely represent fair compensation for the injured party's 104 damages.

At 408, third-party estimate generator 152 determines a range of estimated value for a settlement. In some embodiments, determining the range of estimate value may include identifying a value range that historically similar settlement cases have settled at. The third-party estimate generator 152 may also generate a list identifying and describing information about similar historical settlements, and/or a degree of similarity between the injured party's injury and the injury associated with an individual historical settlement.

At 410, third-party estimate generator 152 transmits an estimated value report for the settlement to the damages settlement service 102, which is received by damages settlement service at step 412.

At 414, damages settlement service 102 generates a settlement report. The settlement report may include the value range that the damages settlement service 102 estimates to be fair value for the injured party's 104 claim, and/or a list identifying and describing information about similar historical settlements. In some embodiments, the settlement report may indicate a level of similarity between the injured party's injury and the injury associated with an individual historical settlement. The settlement report may also include a confidence value relating to a probability that the estimated range is a fair value for the injured party's 104 claim. For example, damages settlement service 102 determines that the similar historical settlements have each settled within a small value range, the settlement report may indicate a high degree of confidence that the estimated range is an accurate estimate of fair value.

At 416, damages settlement service 102 transmits a settlement package to an injured party and/or defendant insurance company. The defendant insurer 110 may verify the validity of the estimated value of the injured party's injury in the settlement report. The defendant insurers 110 may then transmit a settlement offer to the damages settlement service, the injured party 104, or both.

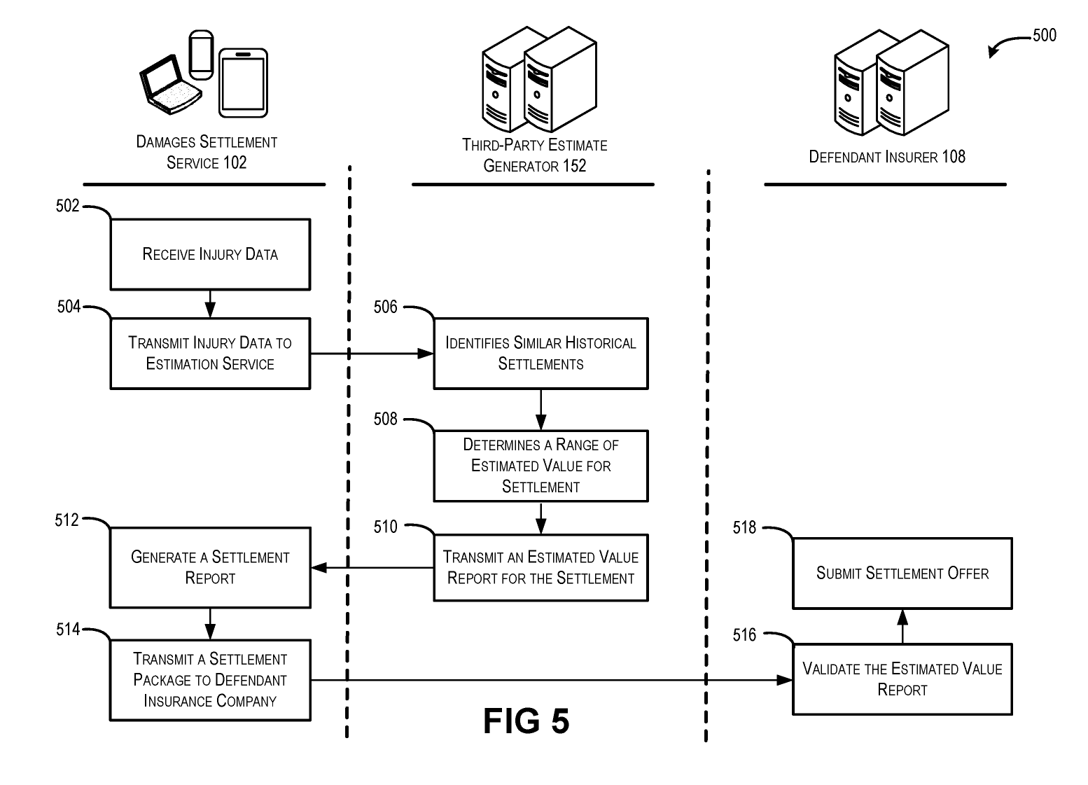

FIG. 5 is a flow diagram of an illustrative process 500 for using a third-party estimation service to efficiently secure optimal settlements from a defendant insurer. The process 500 may be implemented by the computing architecture 200 and in the environment 100 described above, or in other environments and architectures.

At 502, damages settlement service 102 receives injury data. In some embodiments, damages settlement service 102 may receive injury data 116 from one or more computing device 106 associated with an injured party 104. In some embodiments, the damages settlement service 102 may receive the injury data 116 via email, text, SMS, a web interface, application module, or other means for passing injury data 116 between computing device 106 and damages settlement service 102. Alternatively, or in addition, injury data 116 may be entered directly into the damages settlement service 102 via one or more user interfaces (e.g., keyboards, touchscreens, etc.), or may be received from one or more third-party information providers 108 associated with the injured party 104. In some embodiments, damages settlement service 102 may transmit a record request to a third-party information provider 108. The record request may include one or more identifiers or keys associated with the injured party 104, and a request to access information associated with the injured party 104. The damages settlement service 102 may receive an identifier or key from the injured party 104, and may securely access injury data 116 via a third-party information provider 108 by including the identifier and/or key in a record request 120 submitted to the third-party information provider 108.

At 504, the damages settlement service 102 transmits injury data to a third-party estimate service. In some embodiments, the estimate service may be a third-party estimate generator that stores historic settlement data, and estimates the likely value of injury settlements based on the historic data.

At 506, third-party estimate generator 152 identifies similar historical settlements. In some embodiments, the estimate service may identify historical settlements cases that have factual traits in common with the injury data (i.e., same injury, located in same state, same severity, etc.), and determine a range of values that the historically similar cases settled at. For example, the estimate service may compare the injury data 116 associated with the injured party 104 to historical settlement information locally stored by the estimate service, and identify a set of settlement amounts that injuries with similar accident information settled for, and then estimate a settlement range that would likely represent fair compensation for the injured party's 104 damages.

At 508, third-party estimate generator 152 determines a range of estimated value for a settlement. In some embodiments, determining the range of estimate value may include identifying a value range that historically similar settlement cases have settled at. The third-party estimate generator 152 may also generate a list identifying and describing information about similar historical settlements, and/or a degree of similarity between the injured party's injury and the injury associated with an individual historical settlement.

At 510, third-party estimate generator 152 transmits an estimated value report for the settlement to the damages settlement service 102. At 512, damages settlement service 102 generates a settlement report. The settlement report may include the value range that the damages settlement service 102 estimates to be fair value for the injured party's 104 claim, and/or a list identifying and describing information about similar historical settlements. In some embodiments, the settlement report may indicate a level of similarity between the injured party's injury and the injury associated with an individual historical settlement. The settlement report may also include a confidence value relating to a probability that the estimated range is a fair value for the injured party's 104 claim. For example, damages settlement service 102 determines that the similar historical settlements have each settled within a small value range, the settlement report may indicate a high degree of confidence that the estimated range is an accurate estimate of fair value.

At 514, damages settlement service 102 transmits a settlement package to a defendant insurance company. At 516, defendant insurer 108 validates the estimated value report. In some embodiments, the defendant insurer may submit one or more verification request to third-party information providers to verify the validity of the estimated value of the injured party's injury and/or the injury data that the determination of the estimated value was based upon. The verification request may include one or more identifiers and/or keys that identify the desired injury data and/or authorize the defendant insurers to access the desired injury data.

At 518, defendant insurer 108 submits a settlement offer. For example, based off of the information in the settlement package (e.g., estimated value for settlement, similar historical settlements, etc.), information available to the defendant insurer (e.g., internal settlement guidelines, company policy, etc.), or a combination thereof, the defendant insurance company may determine a value that they are willing to settle at. The defendant insurer 108 may then transmit an offer to settle that includes the value to the damages settlement service, the injured party 104, or both.

FIG. 6 is a flow diagram of an illustrative process 600 for protecting private information during transmissions within a system for securing optimal settlements for injured parties. The process 600 may be implemented by the computing architecture 200 and in the environment 100 described above, or in other environments and architectures. The process 600 includes multiple validation protocols for ensuring secure sharing of private information, but those skilled in the art will appreciate that not all the illustrated steps are necessary for secure transmission of private data, and that in some embodiments only a portion the illustrated protocols may be performed, and/or may be performed in a different order.

At 602, a computing device 106 associated with an injured party 104 submits a request for injury data to a third-party information provider 108. The request may include a purpose that the injury data is being requested, the type of injury data that is being requested, and one or more identifiers relating to the desired injury data, the computing device 106, and/or the injured party 104. In some embodiments, an application executing on the computing device 106 may generate and transmit the request. For example, an injured party 104 may input one or more of, a type of injury data being requested, a purpose of the request, an identifier of the entity from which the injury data is being requested, an identifier for a device that is to receive the injury data, an identifier for an entity that is to receive the injury data (e.g., an insurance company, damages settlement service 102, etc.), into an application executing on the computing device 106. The computing device 106 may the compile the input to form the request for injury data, and transmit the request to the third-party information provider 108. In other embodiments, the acts of step 602 may be performed by one or more other entities, such as another computing device, a kiosk, damages settlement service 102, etc.

At 604, the third-party information provider 108 validates the request for injury data from the computing device 106. In some embodiments, validating the request may correspond to causing an application on the computing device 106 to prompt the injured party 104 to enter an identifier (SSN, user name, medical identifier, license number, name, etc.) and/or a password. Alternatively, or in addition, validating the request may include generating and transmitting a password, code, or image to the computing device 106, and then having the password, code, and/or image entered or otherwise scanned into a computing device of the third-party information provider 108. For example, the third-party information provider 108 may generate a unique image that is transmitted to the requesting computing device 106. The injured party 104 may then display the unique image to a sensor associated with the third-party computing device 106 (e.g., camera, barcode scanner, infrared sensor, etc.). In this way, by transmitting a unique image/password/code to the requesting computing device 106, the third-party information provider 108 is able to verify that the computing device 106 that is requesting the injury data is actually associated with an injured party 104 (or other individual) that is authorized to receive the injured data. Validating the request may also include verifying that an IP address of the computing device 106, identification files (e.g., cookies) hosted on the computing device 106, identifiers for an instance of an application that submitted the request, or other identifier is associated with an individual that is authorized to acquire the injury data.

At 606, the third-party information provider 108 transmits an encrypted information file to the computing device 106. The third-party information provider 108 may generate an encrypted file that includes the injury data requested by the computing device 106. The encrypted file may correspond to a password controlled file, a fully encrypted file requiring an encryption key to be read, may be in a format that can only be read by a specific application or instance of an application, or a combination thereof. When transmitting the encrypted information file, the third-party information provider 108 may not include the password and/or encryption key that are required to access the injury data. In some embodiments, the third-party information provider 108 transmit the password and/or encryption key in separate secure transmission, at a different time, via a different transmission medium, or a combination thereof. For example, the third-party information provider 108 may transmit the encrypted information over a Bluetooth connection, and transmit the passcode via a SMS to the computing device 106. Alternatively, one or more of the password, key, or encrypted information file may be transmitted over a wired connection between a computing device associated with the third-party information provider 108 and computing device 106. In some embodiments, the encrypted information file may only be able to be read by an instance of an application executing on the computing device 106, during a particular period of time (e.g., is only readable within 48 hours of being transmitted), or both. In some embodiments, accessing the encrypted file will require a new passcode/key to access after a period of time expires.

At 608, computing device 106 transmits the encrypted information to the damages settlement service 102. The encrypted information may be transferred via a wired or wireless connection. The encrypted information may include injury data 116 associated with the inured party 104. In some embodiments, transmitting the encrypted information may include uploading the encrypted information via a website, a software application, transmission to a kiosk/other computing device associated with the damages settlement service, by attachment to a digital transmission, or other means.

At 610, damages settlement service 102 transmits a request for the key for the encrypted information file. The request for the key may be sent to the computing device 106, the third-party information provider, or both. The request may include one or more of an identifier for the encrypted information file, a request for a key, a time associated with the request, an identifier for the injured party 106, a code that verifies the identity of the damages settlement service 102. In some embodiments, the request may be transmitted via a software application, a website, etc.

At 612, third-party information provider 108 transmits a validation request to the computing device 106. In some embodiments, the third-party information provider 108 may transmit a notification to the computing device 106 that notifies the injured party 104 that the damages settlement service 102 is trying to access his or her personal information. The notification may identify the entity requesting the personal information, and/or include a selectable option to authorize the third-party information provider to provide the personal information to the entity. In some embodiments, the notification may include data that causes the computing device 106 to launch an application associated with the third-party information provider 108, wherein upon launch, the application presents one or more of: information relating to the requesting entity, information being requested, and functionality for authorizing the third-party information provider to provide the personal information to the entity.

In some embodiments, the notification may be transmitted over one or more mediums such as WiFi-based communication such as via frequencies defined by the IEEE 802.11 standards, short range wireless frequencies such as Bluetooth®, or any suitable wired or wireless communications protocol that enables the respective computing device to interface with the other computing devices (e.g., telephone networks). In this way, the injured party 104 may receive the notification that an entity is trying to access its personal data even when his or her computing device 106 is not connected to the internet and/or an application associated with the third-party information provider 108 is not open/being viewed by the injured party 104.

At 614, computing device 106 validates the key request. Validating the key request may include the computing device 106 receiving: a selection associated with validation of the request, an input and/or lack of input within a set amount of time, a submission of a password or code, a fingerprint or other ID scan included within sensor data from a sensor associated with the computing device 106, or a combination thereof. For example, to validate the key request, the computing device 106 may need to receive a verification of the injured party 104 (e.g., username/password, fingerprint, voice recognition, etc.), and an input associated with authorization that the request is approved. An input may include an interaction between a user and a keyboard or other interface tool, an interaction with a touchscreen, a voice command, or other interactions between the user and the computing device 106.

At 616, third-party information provider 108 transmits the key to the damages settlement service 102. In some embodiments, the third-party information provider 108 may generate the encryption key for the encrypted information. The encryption key may be generated based on the time of the request, may only work for a set period of time, and may only work for an instance of a software application associated with the damages settlement service DMS 102.

At 618, damages settlement service 102 accesses the injury data in the encrypted information file. The damages settlement service 102 may use encryption key to open the file, and then extract the injury data 116 from the file. The damages settlement service 102 may then generate a settlement package 124 based on the injury data 116, or send the injury data to defendant insurers 110 and/or third-party estimate generator 152. In some embodiments, transmitting the injury data 116 may correspond to the damages settlement service 102 modifying the injury data 16 to remove personal identification information associated with the injured party 104 (e.g., SSNs, names, phone numbers, or other identifying information), and transmitting the modified injury data. In this way, the defendant insurers 110 and/or third-party estimate generator 152 may analyze and make determinations/estimations based on the injury data 104 of the injured party, without knowing the identity of the injured party.

Alternatively, or in addition, transmitting the injury data 116 may correspond to the damages settlement service 102 sending the encrypted information file. Where the defendant insurers 110 and/or third-party estimate generator 152 want to verify the injury data 116 and/or access the encrypted file, the defendant insurers 110 and/or third-party estimate generator 152 may request the encryption key from the third-party information provider 108, and the process may continue from step 610.

The techniques discussed herein may be implemented in a wide variety of contexts, such as automobile accidents, medical malpractice, product liability, etc.

### Conclusion

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. An injury settlement system, comprising:
at least a first non-transitory computer-readable storage medium to store first instructions which, in response to being performed by one or more first processors, cause a damages settlement system to:
receive, from a computing device, first injury data associated with first injuries of an injured party; and
transmit, to a settlement estimation service, the first injury data and a request for an estimated fair value for the injured party;
at least a second non-transitory computer-readable storage medium to store second instructions which, in response to being performed by one or more second processors, cause the settlement estimation service system to:
identify, based at least in part the first injury data, historical settlement data associated with a historical settlement, the historical settlement data indicating:
(i) second injury data associated with second injuries that are similar to the first injuries, and
(ii) a value that the second injuries were settled for; and
estimate, based at least in part on the historical settlement data, the estimated fair value for the injured party; and
transmit, to the damages settlement service, the estimated fair value for the injured party, wherein the damages settlement service is further configured to transmit to the computing device a settlement report that indicates the estimated fair value for the first injuries.

2. The injury settlement system of claim 1, wherein the settlement estimation service maintains a database of one or more instances of historical settlement data associated with one or more historical settlements, individual instances of the historical settlement data indicating (i) corresponding injury data associated with corresponding injuries, and (ii) a corresponding value that the corresponding injuries were settled for, and wherein the second instructions further cause the settlement estimation service to:
determine, based on the injury data and the one or more instances of historical settlement data, that the first injury data is similar to the second injury data; and
wherein the historical settlement data is identified based at least in part on the first injury data being similar to the second injury data.

3. The injury settlement system of claim 1, wherein the second instructions further cause the settlement estimation service to:
determine a level of similarity between the first injuries of the injured party and the second injuries, and
wherein the historical settlement data is identified based at least in part on the level of similarity meeting a threshold value.

4. A computer-implemented method, comprising:
receiving, from a computing device and by a settlement service, first injury data associated with first injuries of an injured party; and
identifying, based at least in part the first injury data, historical settlement data associated with a historical settlement, the historical settlement data indicating:
(i) second injury data associated with second injuries that are similar to the first injuries, and
(ii) a value that the second injuries were settled for; and
generating, by the settlement service and based at least in part on the historical settlement, a settlement report that indicates an estimated fair value for the first injuries.

5. The method of claim 4, wherein the value is a first value, and the method further comprises:
determining that the first injuries of the injured party were settled for a second value; and
generating a new instance of historical settlement data that indicates (i) the first injury data associated with the first injuries, and (ii) the second value.

6. The computer-implemented method of claim 4, wherein, the settlement report further indicates a degree of confidence that the estimated fair value is accurate.

7. The computer-implemented method of claim 4, wherein receiving the first injury data comprises receiving an encrypted file, and the method further comprises:
transmitting, to a third-party information provider, a request for an encryption key;
receiving, from the third-party information provider, the encryption key; and
accessing the first injury data using the encryption key.

8. The computer-implemented method of claim 7, further comprising:
transmitting, by the third-party information provider and to the computing device, a notification that the settlement service is attempting to acquire the encryption key;
receiving, by the third-party information provider and from the computing device, an authorization to transmit the encryption key; and
wherein the third-party information provider transmits the encryption key to the settlement service based at least in part on the authorization.

9. The computer-implemented method of claim 8, wherein the notification includes data configured to cause an application executing on the computing device to present an interface that comprises (i) information associated with the settlement service, and (ii) an option to authorize the third-party information provider to provide the encryption key to the settlement service.

10. The computer-implemented method of claim 4, further comprising determining, based at least in part on the historical settlement data, a likelihood that hiring an attorney would result in a larger estimated settlement.

11. The computer-implemented method of claim 10, further comprising:
estimating, based at least in part on the historical settlement data, an estimated change in value associated with obtaining legal assistance; and
wherein, based at least in part on the estimated change in value meeting a threshold value, the settlement report further indicates a recommendation that the injured party consider obtaining legal assistance.

12. A system, comprising:
at least one non-transitory computer-readable storage medium to store instructions which, in response to being performed by one or more processors, cause the system to:
receive, from a computing device, first injury data associated with first injuries of an injured party; and
identify, based at least in part the first injury data, historical settlement data associated with a historical settlement, the historical settlement data indicating:
(i) second injury data associated with second injuries that are similar to the first injuries, and
(ii) a value that the second injuries were settled for; and
generate, based at least in part on the historical settlement data, a settlement report that indicates an estimated fair value for the first injuries.

13. The system of claim 12, wherein the instructions further cause the system to:
determine a level of similarity between the first injuries of the injured party and the second injuries, and
wherein the historical settlement data is identified based at least in part on the level of similarity meeting a threshold value.

14. The system of claim 13, wherein the instructions further to cause the system to:
access, on a memory accessible by the system, a database of one or more instances of historical settlement data associated with one or more historical settlements, individual instances of the historical settlement data indicating (i) corresponding injury data associated with corresponding injuries, and (ii) a corresponding value that the corresponding injuries were settled for;
determine, based on the injury data and the one or more instances of the historical settlement data, that the first injury data is similar to the second injury data; and
wherein the historical settlement data is identified based at least in part on the first injury data being similar to the second injury data.

15. The system of claim 12, wherein the instructions further to cause the system to:
transmit a request to a third-party information provider for third injury data associated with the first injuries of the injured party; and
receive from the third-party information provider, the third injury data.

16. The system of claim 12, wherein the instructions further to cause the system to:
transmit the first injury data to a third-party estimation service; and
receive from the third-party estimation service, the estimated fair value for the injured party.

17. The system of claim 16, wherein the third-party estimation service maintains a database of one or more instances of historical settlement data associated with one or more historical settlements, individual instances of the historical settlement data indicating (i) corresponding injury data associated with corresponding injuries, and (ii) a corresponding value that the corresponding injuries were settled for, and wherein the third-party estimation service determines the estimated fair value based at least in part on the one or more instances of the historical settlement data.

18. The system of claim 12, wherein the value is a first value, and the instructions further to cause the system to:
determine that the first injuries of an injured party were settled for a second value; and
generate a new instance of historical settlement data that indicates (i) the first injury data associated with the first injuries, and (ii) the second value.

19. The system of claim 11, wherein the instructions further to cause the system to:
receive accident identification data associated with the first injuries to the injured party; and
transmit, to the computing device and based on the identification data, a recommendation to use the system to settle the first injures.

20. The system of claim 11, wherein the instructions further to cause the system to:
estimate, based at least in part on the historical settlement data, an estimated change in value associated with obtaining legal assistance; and
wherein, based at least in part on the estimated change in value meeting a threshold value, the settlement report further indicates a recommendation that the injured party consider obtaining legal assistance.
